(19) United States
(12) Patent Application Publication
(10) Pub. No.: US 2014/0156347 A1
(43) Pub. Date: Jun. 5, 2014

(54) Enhanced Market Basket Analysis

(71) Applicant: FAIR ISAAC CORPORATION, Roseville, MN (US)

(72) Inventors: Rakhi Agrawal, Uttarakhand (IN); Shafi Rahman, Bangalore (IN); Amit Kiran Sowani, Bangalore (IN)

(73) Assignee: FAIR ISAAC CORPORATION, Roseville, MN (US)

(21) Appl. No.: 13/706,317

(22) Filed: Dec. 5, 2012

(51) Int. Cl. G06Q 30/02

(52) U.S. Cl. CPC G06Q 30/0202
USPC 705/7.31

(57) ABSTRACT

The current subject matter describes a generation of a score based on an enhanced market basket analysis (eMBA). An eMBA model can receive historical data characterizing historical purchases of a plurality of products over a specified time-period. In response, the eMBA model can generate baskets, which can include data that is causal and predictive. The generated baskets can be provided as an input to a group generator. The group generator can then generate product groups and confidence values. The product groups and confidence values can be provided to a score generator. In run-time, the score generator can receive current product data, and in return, can use the product groups and confidence values to generate a score. The score can characterize a likelihood of a purchase of the product by a corresponding customer associated with the product group. Related methods, apparatuses, systems, techniques and articles are also described.

### TECHNICAL FIELD

The subject matter described herein relates to scoring customers based on an enhanced market basket analysis.

### BACKGROUND

In the retail industry, a lot of resources are typically spent on marketing and sales activities. A primary form of marketing is provision of offers (for example, coupons) on products that become available for purchase by customers. The offers can be provided based on a purchase history of the customers. For example, if a customer has been historically purchasing a hair conditioner, further offers on the hair conditioner can be provided to the customer. However, such a provision does not take into account whether the purchase of the hair conditioner can be predicted based on an earlier purchase of a predictor product, such as a shampoo.

### SUMMARY

The current subject matter describes a generation of a score of a customer based on an enhanced market basket analysis (eMBA). An eMBA model can receive historical data characterizing historical purchases of a plurality of products over a specified time-period. In response, the eMBA model can generate baskets, which can be associated with a causal status and a predictive nature of each product in those baskets. The generated baskets can be provided as an input to a group generator. The group generator can then generate product groups and confidence values. The product groups and confidence values can be provided to a score generator. In run-time, the score generator can receive current product data, and in return, can use the product groups and confidence values to generate a score. The score can characterize a likelihood of a purchase of the product by a corresponding customer associated with the product group. Based on the score, a merchant can determine an appropriate offer (for example, a discount offer) on the product to be provided to the customer. Related apparatus, systems, techniques and articles are also described.

In one aspect, data characterizing a product available for purchase can be received. The product can be associated with at least one subgroup that includes the product. The at least one subgroup can be at least one of a plurality of groups of historical products that have been shown to be frequently purchased together. Each subgroup can be associated with one or more confidence values. The data characterizing the groups can include causal statuses of the historical products. Using the one or more confidence values, a score can be generated. The score can characterize a likelihood of a purchase of the product by a corresponding customer associated with the at least one subgroup. Data characterizing the score can be provided. The receiving, the associating, the generating, and the providing can be implemented by at least one data processor forming part of at least one computing system.

In some variations one or more of the following can optionally be included.

The data characterizing the product can be an identifier of the product. The data characterizing the product can include at least one of: identity of the product, name of the product, manufacturer of the product, and a stock keeping unit associated with the product.

The groups can be associated with a plurality of confidence values. The one or more confidence values associated with the at least one subgroup can be selected from the plurality of confidence values associated with the groups.

Each causal status can be one of a predictor and a target. A causal status of the product available for purchase can be a target. The product can be predicted based on one or more products that have a predictor causal status.

The score can be a highest confidence value in the one or more confidence values associated with each subgroup. In another implementations, the score can be a mathematical multiplication product of a predetermined number of top confidence values of each subgroup. In a further implementation, the score can be a mathematical average of a top predetermined number of confidence values.

The one or more confidence values can be generated by performing the following. Based on historical data collected over a time-period, baskets can be generated. The time-period can be a predetermined time-period that can be specified by the merchant. Each basket can characterize corresponding historical products purchased by a customer within the time-period. The historical data can characterize historical purchases of the historical products between customers and merchants. Using the baskets, the groups of products can be formed. The groups of products can be products that are frequently purchased together by a customer. One or more ratios for the at least one subgroup can be determined. Each ratio being can be obtained by dividing a numerator by a denominator. The numerator can be a simultaneous occurrence of the one or more products and other products in the groups. The denominator can be an occurrence of the other products in the groups. The one or more ratios can characterize the one or more confidence values.

The baskets can be generated by performing the following. Transaction data can be extracted from the historical data. The transaction data can include a unique identification of a customer for each purchase, a date of each purchase, and a stock keeping unit associated with each purchase. A product map mapping each stock keeping unit with a respective product can be obtained. Using the transaction data and the product map, basket identifiers can be generated. The basket identifiers can identify the baskets and one or more product identifiers associated with each basket identifier. Each basket identifier can characterize a time-period when a corresponding customer made a purchase. The product identifier can characterize a product associated with the purchase and a causal status associated with the purchase.

The causal status can identify the purchased product as one of: a product used to predict a purchase of another product and a product obtained based on a purchase of another product.

The groups of products can be performed by performing the following. The baskets can be received. Each basket can be associated with respective products. A first table including each product and corresponding occurrence of each product in the baskets can be generated. A second table can be generated by removing, from the first table, one or more products that have values of occurrence below a first threshold. A third table can be generated by pairing each product in the second table with every other product in the second table to form product-sets including pairs of products. A fourth table can be generated, wherein the fourth table can include each product-set and an occurrence of the corresponding pair of products in the baskets. A fifth table can be generated by removing one of more product-sets that have values of occurrence below a second threshold. The product-sets in the fifth table can be the formed groups of products. The first threshold can be equal to the second threshold.

The generating of the score can be further based on a trend associated with the purchase. The trend can characterize a time-interval when the product is likely to be purchased. The trend can be determined based on a buffer window value provided by a merchant.

Computer program products are also described that include non-transitory computer readable media storing instructions, which when executed by at least one data processors of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors that either are within a single computing system or are distributed among two or more computing systems.

The subject matter described herein provides many advantages. For example, scores for customers can be generated fairly accurately based on historical data collected over a short time-period, such as about 2 to 3 months, as compared to longer times periods, such as 1 to 2 years, as in conventional systems. Thus, merchants can provide accurate offers without requiring historical data collected over a long time-period. Such a collection over a short time-period can be advantageous for merchants that are new in the market and do not have access to historical data collected over long time-period, as the current enhanced system allows an accurate provision of offers (for example, discount offers) even with a short history. Moreover, such a collection over a short time-period can be advantageous for merchants that sell products that can only have a short history and may not have a long history, as the current enhanced system allows an accurate provision of offers (for example, discount offers) even with a short history. Further, the enhanced system described herein can be easier to develop as compared to conventional systems. Additionally, the enhanced system allows a scoring and subsequent provision of offers based on a causal status and a predictive nature of a product, both of which can be taken into account while generating product baskets from the historical data. Such an accounting of causal status and predictive nature can advantageously cause accurate scoring of customers for a product that becomes available for purchase, thereby allowing an effective provision of offers. Such effective provision of offers can result in significant cost advantages, and other business advantages.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a generation of a score based on an enhanced market basket analysis;

FIG. 2 is a diagram illustrating a design-time generation of product groups and confidence values;

FIG. 3 is a first diagram illustrating a generation of baskets;

FIG. 3A is a second diagram illustrating a generation of baskets;

FIG. 4 is a diagram illustrating a forming of product groups;

FIG. 4A is a flow-diagram illustrating a parallel computing technique for forming product groups;

FIG. 5 is a diagram illustrating a generation of confidence values for formed groups;

FIG. 6 is a system diagram illustrating a score generator generating, in run-time, a score when a new/current product becomes available for purchase;

FIG. 7 is a diagram illustrating the generation of the score;

FIG. 7A is a diagram illustrating a more accurate selection of predictor products for a particular target product when the enhanced market basket analysis is implemented as compared to when a conventional market basket analysis is implemented;

FIG. 8 is a diagram illustrating an example of an improvement in an average redemption rate when offers on products are provided based on the scores generated using the enhanced system; and

FIG. 9 is a diagram illustrating an example of an improvement in an average detection rate when offers on products are provided based on the scores generated using the enhanced system.

Like reference symbols in the various drawings indicate like elements.

### DETAILED DESCRIPTION

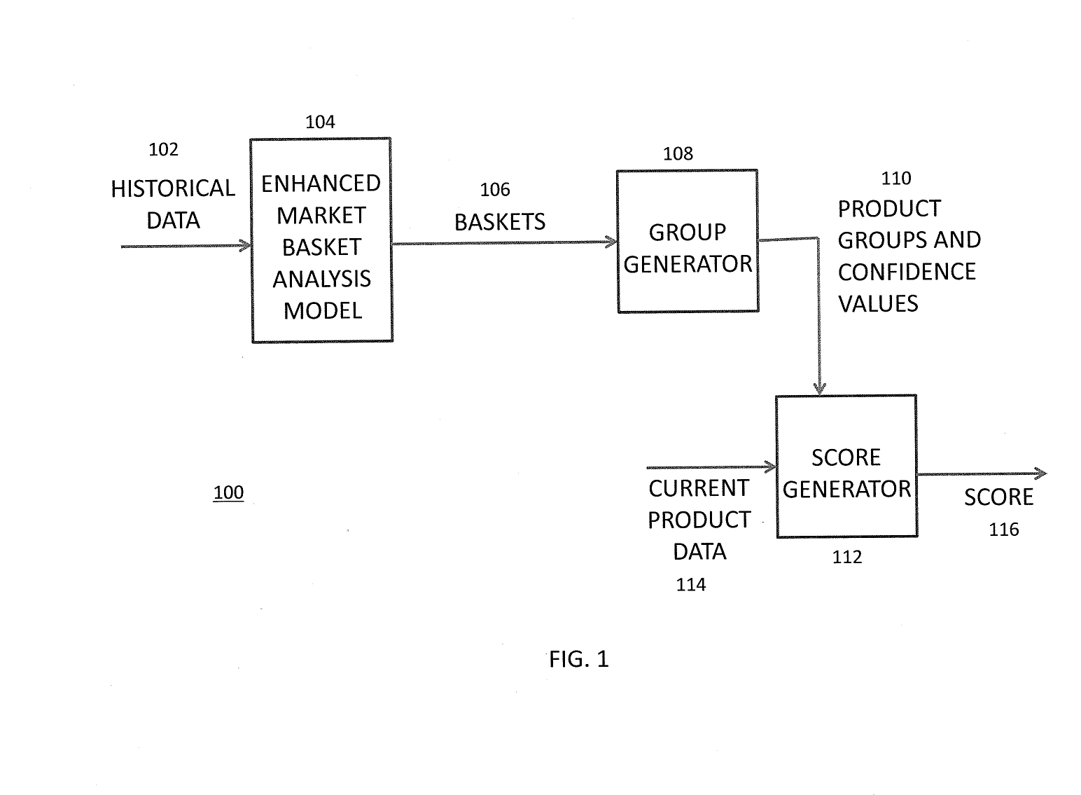

FIG. 1 is a diagram 100 illustrating a generation of a score based on an enhanced market basket analysis (eMBA). Historical data characterizing historical purchases of a plurality of products can be received at an enhanced market basket analysis model 104. In response, the market basket analysis model 104 can generate baskets 106, which can include data that is causal and predictive. The baskets 106 can be provided as input to a group generator 108. The group generator 108 can then generate product groups and confidence values 110. The product groups and confidence values 110 can be provided to a score generator 112. In run-time, the score generator 112 can receive current product data 114, and in return, can use the product groups and confidence values 110 to generate a score 116. The score 116 can characterize a likelihood of a purchase of the product by a corresponding customer associated with the product group.

The score can be provided to a merchant on a graphical user interface. The provision can be over a network, such as internet, local area network, wide area network, Bluetooth network, and any other network. The score can be displayed to a merchant on a graphical user interface. Based on the score, the merchant can determine and subsequently provide an offer (for example, a discount offer) on the product to the customer.

The generation of the product groups and confidence values 110 can occur in design-time, and the generation of the score 116 can occur in run-time. The run-time can be a time when a current/new product becomes available in real-time for purchase at a sales location of a merchant for a plurality of customers. Herein, a current/new product refers to a product, at least two months of transaction historical data associated with which is available. The score can characterize a likelihood of a purchase of the current/new product by a corresponding customer.

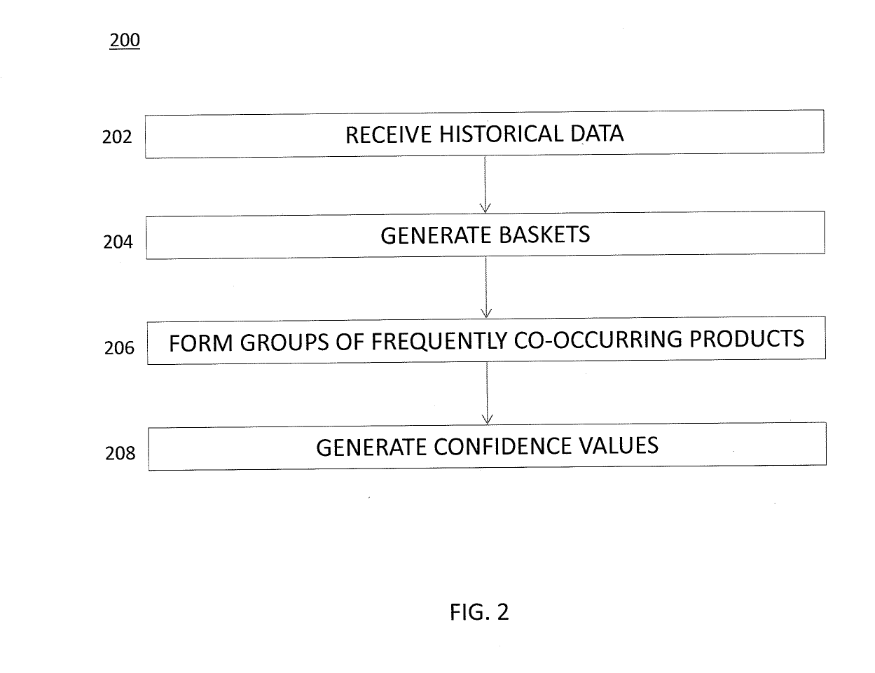

FIG. 2 is a diagram 200 illustrating a design-time generation of product groups and confidence values 110.

Historical data 102 can be collected over a past time-period, such as past one month, two months, six months, one year, two years, five years, or other predetermined period. In a case where a merchant may be newly established and does not have access to historical data and/or a case where a product is newly developed and does not have a long purchase history, the time-period for collection of data can be advantageously small, such as 2 or more months. Historical data can include historical purchases between merchants and customers. This historical data 102 can be received, at 202, at an enhanced market basket analysis model 104.

The enhanced market basket analysis model 104 can generate, at 204, baskets 106 of data. The baskets 106 can include causal and predictive data associated with the products in the baskets. For example, the data in the baskets 106 can indicate whether the purchase of a particular product can be used to predict purchase of other one or more products, and whether the purchase of a particular product can be predicted based on previous purchase of other one or more products. Such a generation of baskets 106 is described in more detail below with respect to diagram 300.

The baskets 106 can be provided to the group generator 108. The group generator 108 can use the baskets to form, at 206, groups of products that may be frequently purchased together by a customer. Such a forming of product groups is described in more detail below with respect to diagram 400.

One or more confidence values associated with each group can be generated, at 208. Each confidence value can be generated by dividing a numerator by a denominator, wherein the numerator is a simultaneous occurrence of the one or more products and other products in the groups, and the denominator is an occurrence of the the other products in the groups. Such a generation of one or more confidence values is described in more detail below with respect to diagram 500.

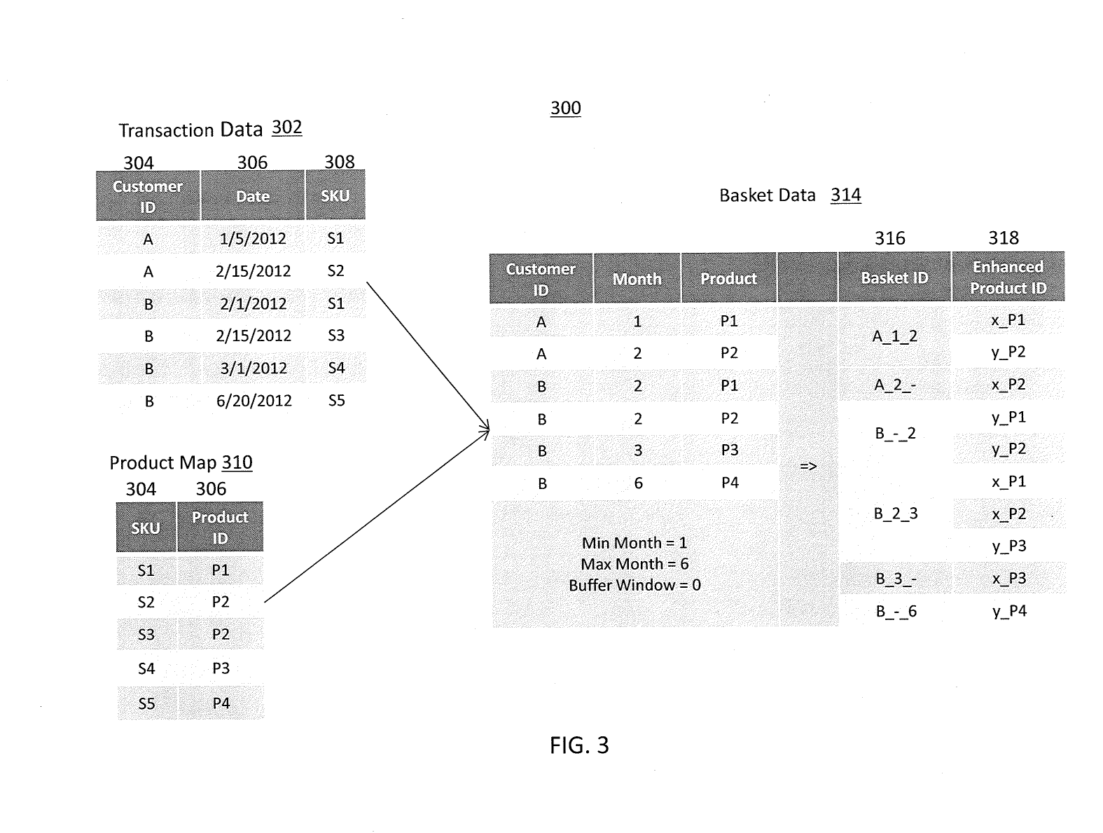

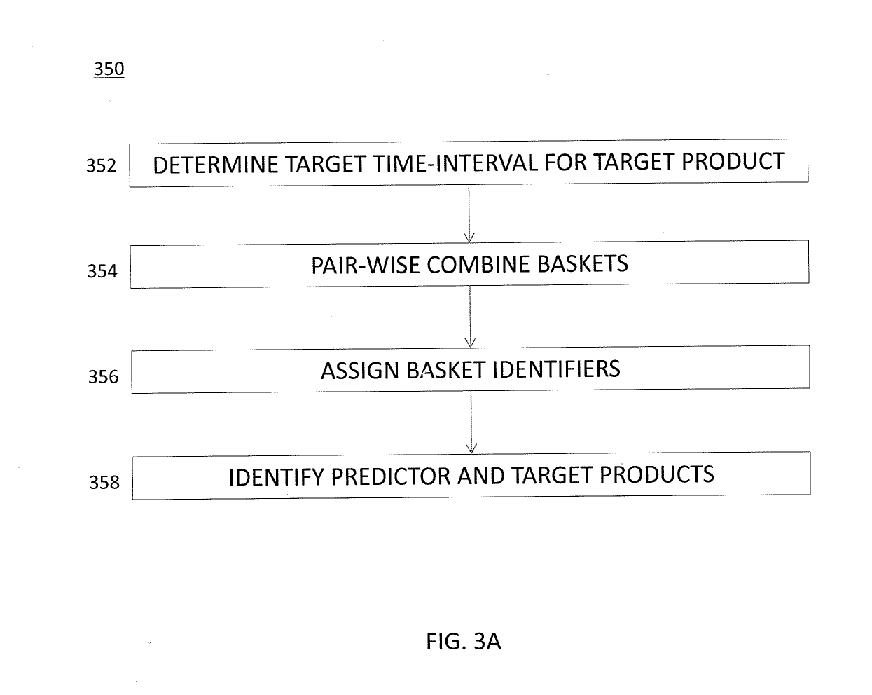

FIG. 3 is a first diagram illustrating a generation of baskets 106 at 204.

The transaction data 302 can be extracted from the historical data 102. The transaction data can include a customer identifier 304 for each purchase of a respective product, a date 306 (including month, day, year, and/or time) of each purchase, and a stock keeping unit (SKU) 308 associated with each purchase.

A product map 310 can be obtained. The product map 310 can map each stock keeping unit 308 with a product identifier 312.

Using the transaction data 302 and the product map 310, basket data 314 for the baskets 106 can be generated. The basket data 314 can include basket identifiers 316 and enhanced product identifiers 318. The generating of the basket data 314 can be based on a buffer window value, which can characterize a future time-interval (also referred to as a future trend) for which a likelihood of purchase of the target data needs to be computed. A buffer window value of zero, as shown in diagram 300, can characterize that a prediction for the purchase of the target product is made for a time interval subsequent to the time interval of purchase of the predictor product. For example, if the predictor time-interval for the purchase of the predictor product is a particular time interval, the target time interval for purchase of the target product is an immediately subsequent time-interval.

Although a buffer window values of zero has been described above, in some other implementations, other buffer window values can also be used, such as one, two, three, four, five, and so on. An buffer window value of “n” characterizes that a prediction for the purchase of the target product is made for a (n+1)^{th} time-interval subsequent to the time interval of purchase of the predictor product. For example, when n=1 and if the predictor time-interval for the purchase of the predictor product is a particular time interval, the target time interval for purchase of a target product is the second subsequent time-interval after the predictor time-interval.

Each basket can be identified by basket identifiers 316. Each basket identifier 316 can characterize a time-period when a corresponding customer made a purchase. The basket identifier 316 can have a form of CustomerID_MonthOfPurchaseOfPredictorProduct_MonthOfPurchaseOfTargetProduct. For example, the basket identifier A_{—}1_{—}2 can indicate that customer A purchased a predictor product in month 1, and purchased a target product in month 2. Further, the basket identifier A_{—} 2_—can indicate that the customer A purchased a predictor product in month 2, and then did not purchase a target product. The basket identifier B_-_{—}2 can indicate that the customer B did not purchase a predictor product, and purchased a target product in month 2. Similarly, the basket identifier B_{—}2_{—}3 can indicate that customer B purchased a predictor product in month 2, and then purchased a target product in month 3. Further, the basket identifier B_{—}3_—can indicate that customer B purchased a predictor purchase in month 3, and then did not purchase a target product. Furthermore, the basket identifier B_-_{—}6 can indicate that the customer B did not purchase a predictor product, and then purchased a target product.

A predictor product can be used to predict other target products. A target product can be predicted based on one or more predictor products. For example, an automobile can be a predictor product, and gasoline can be a target product.

Based on the basket identifier 316 and the data obtained from the transaction data 302 and the product map 310, the enhanced product identifiers 318 can be generated. The enhanced product identifier can indicate a causal status associated with the purchase and a product associated with the purchase. For example, the enhanced product identifier x_P1 can indicate that P1 is a predictor product for this basket. Further, the enhanced product identifier y_P2 can indicate that P2 is a target product for this basket. Similarly, for other enhanced product identifiers, “x” can indicate that the product is a predictor product, and “y” can indicate that the product is a target product.

FIG. 3A is a second diagram 350 illustrating a generation of baskets 106 at 204. A merchant can provide a buffer window value. Based on the buffer window value, a target trend (that is, a target time interval for which the likelihood of purchase of the target product is to be computed) can be determined at 352. Based on the target trend, trend level baskets can be pair-wise combined at 354. Basket identifiers can be assigned at 356. The basket identifiers can be a combination of a customer identifier, a predictor trend, and a target trend. The products can be identified, at 358, as predictor products and target products. For example, prefix “x” can be prefixed to predictor products associated with a predictor trend, and prefix “y” can be prefixed to target products associated with a target trend.

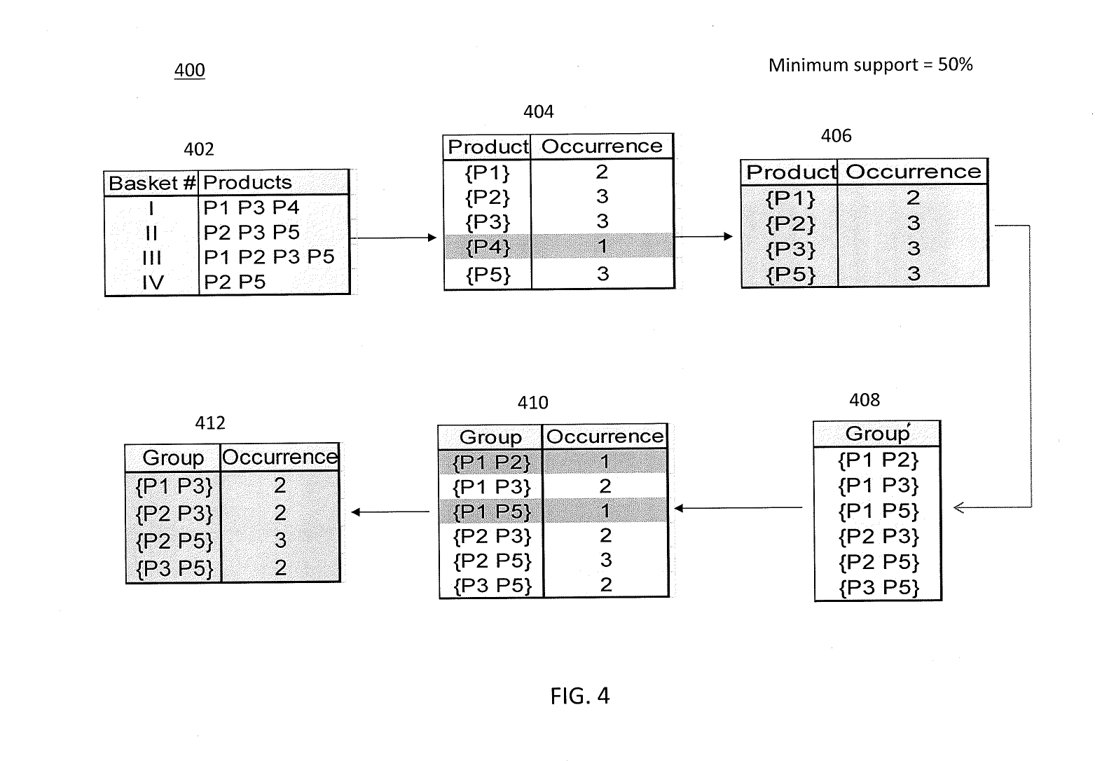

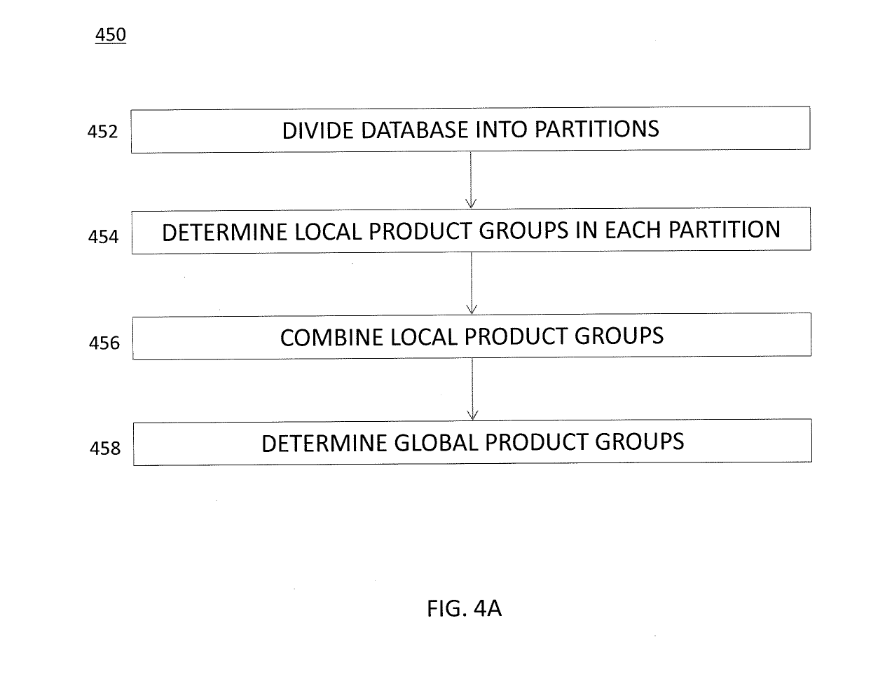

FIG. 4 is a diagram 400 illustrating a forming of product groups at 206.

A database 402 including each basket and associated products can be obtained from the historical data 102. For example, products P1, P3, and P4 can exist in basket I; products P2, P3, and P5 can exist in basket II; and so on, as shown.

An occurrence of each product in the baskets can be determined to generate a first table 404. The occurrence of a product in a basket can be a number of baskets in which the product occurs. For example, if a customer purchases a shampoo in two baskets, the occurrence for the product shampoo is two.

From the first table 404, one or more products that have values of occurrence below a first threshold can be removed to generate a second table 406. In one implementation, the first threshold can be characterized by a minimum support value of 50%. In this implementation, the row with product P1 having an occurrence of 1 (that is, the row with product P1 occurring a single time) can be removed from the first table 404, as occurrence 1 is below the first threshold. Thus, the second table 406 can include the products that have an occurrence of 2 or more.

By pairing each product in the second table 406 with every other product in the second table 406, a third table 408 can be generated to form groups (for example, product-sets) including pairs of products. For example, product P1 is combined with each of P2, P3, and P5; P2 is combined with each of P1, P3, and P5; P3 is combined with each of P1, P2, and P5; and P5 is combined with each of P1, P2, and P3, as shown in the third table 408.

A fourth table 410 can be generated. The fourth table 410 can include the groups of the third table 408, and an occurrence of each group in the baskets of database 402.

The rows of one of more groups that have occurrence below a second threshold in the fourth table 410 can be removed to generate a fifth table 412. The second threshold can be can be characterized by a minimum support value of 50%. In every iteration, a same threshold can be used. For example, the first threshold can be equal to the second threshold. In this implementation, the row with group {P1 P2} and the row with group {P1 P5} have an occurrence of 1, and can be removed from the fourth table 410 to generate the fifth table 412. Thus, the fifth table 412 can include the groups that have an occurrence of 2 or more in the baskets of database 402. The groups/product-sets in the fifth table 412 can be the product groups that are a part of 110.

It may be noted that while 2 iterations have been described to form the product groups, more number of iterations can be performed based on the obtained historical data. Further, while each illustrated product group in the fifth table 412 includes the same number of products, in some other implementations, the final product groups can have different number of products by changing the requirement regarding pairing of the products to form product groups. For example, in some implementations, four products may be selected for a first set of groups, three products may be selected for a second set of groups, and two products (that is, pairs) may be selected for a third set of groups, as noted below in table 502.

FIG. 4A is a flow-diagram 450 illustrating a parallel computing technique for forming of product groups at 206. A database including historical transactions can be divided into a plurality of partitions at 452. Local product groups can be determined, at 454, in each partition. For different partitions, the local products groups can be determined in parallel, thereby saving time, which can be more advantageous when the historical data is large. Each local product group can include one or more frequently occurring products in the respective partition. Different local product groups can be combined at 456 to form candidate product groups. The candidate product groups can be used to determine, at 458, global product groups. These global product groups can be the groups formed at 206.

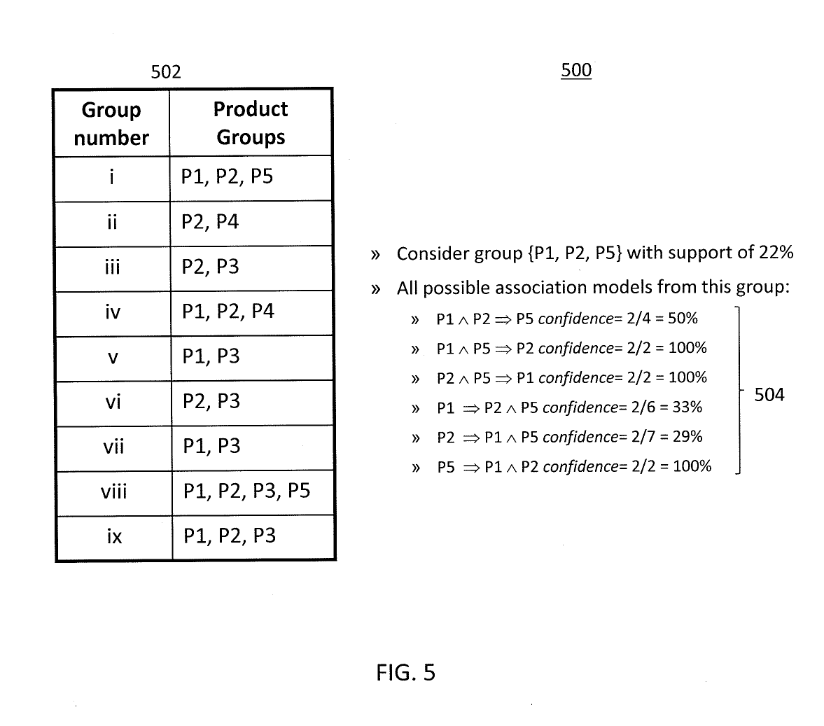

FIG. 5 is a diagram 500 illustrating a generation of confidence values for each product-group at 208. Table 502 can include the final product groups, which can be formed as described above. The confidence values can be calculated/generated for one or more products in each group. Each confidence value can characterize a corresponding confidence/likelihood of a purchase of at least one product of the corresponding group subsequent to a purchase of other co-occurring products of the group. The confidence value for the one or more products in each group can determined by dividing a numerator by a denominator, wherein the numerator is an occurrence of the one or more products with other products in the group in the table 502, and wherein the denominator is an occurrence of the other products in the table 502.

For example, consider the group i, which has products P1, P2, and P5, with a support value of 22%. The confidence values 504 of each possible association between these products can be determined as shown. The symbol “ [symbol] ” can characterize co-occurrence of the products on the left and right of it. The symbol “ [symbol] ” can characterize that the one or more products on left of it are predictor products, and one or more products on the right of it are target products. The confidence value for P5 in association “P1 ̂P2 [symbol] P5” can be determined by dividing 2 (which is an occurrence of P5 with P1 and P2 in the table 502) by 4 (which is an occurrence of P1 and P2 in the table 502). Similarly, other confidence values can be generated for each association in each group.

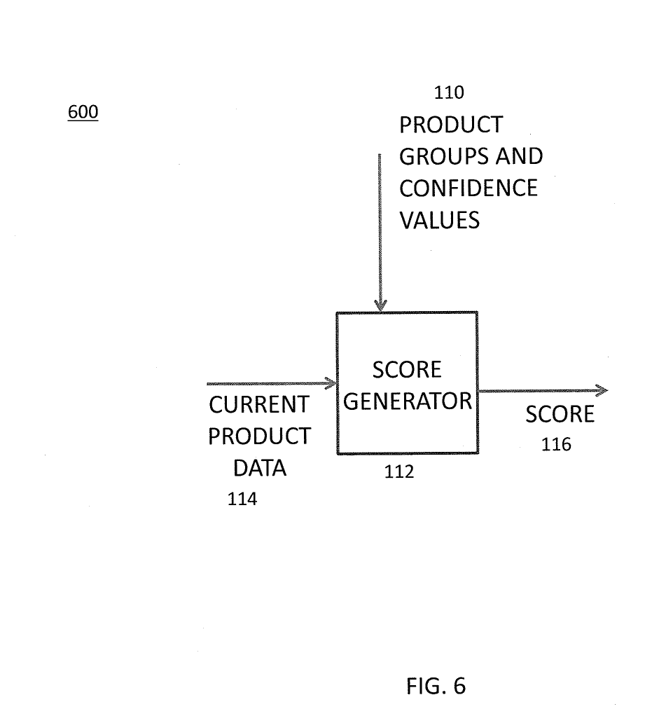

FIG. 6 is a system diagram 600 illustrating a score generator 112 generating, in run-time, a score 116 when a new/current product becomes available for purchase. Herein, a new/current product refers to a product, at least two months of transaction historical data associated with which is available. The product groups and confidence values 110, generations of which are described above, can be provided to the score generator 112. The score generator 112 can receive current product data 114, and in return, can use the product groups and confidence values 110 to generate a score 116. The score 116 can characterize a likelihood of a purchase of the product by a corresponding customer associated with the product group. The generation of score 116 is described in more detail below with respect to diagram 700.

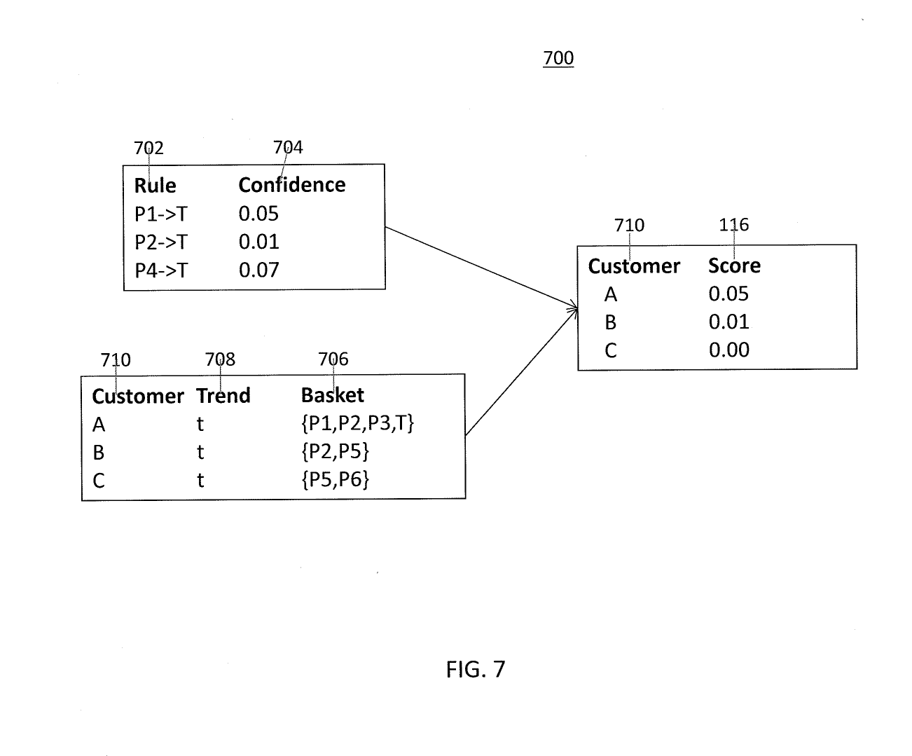

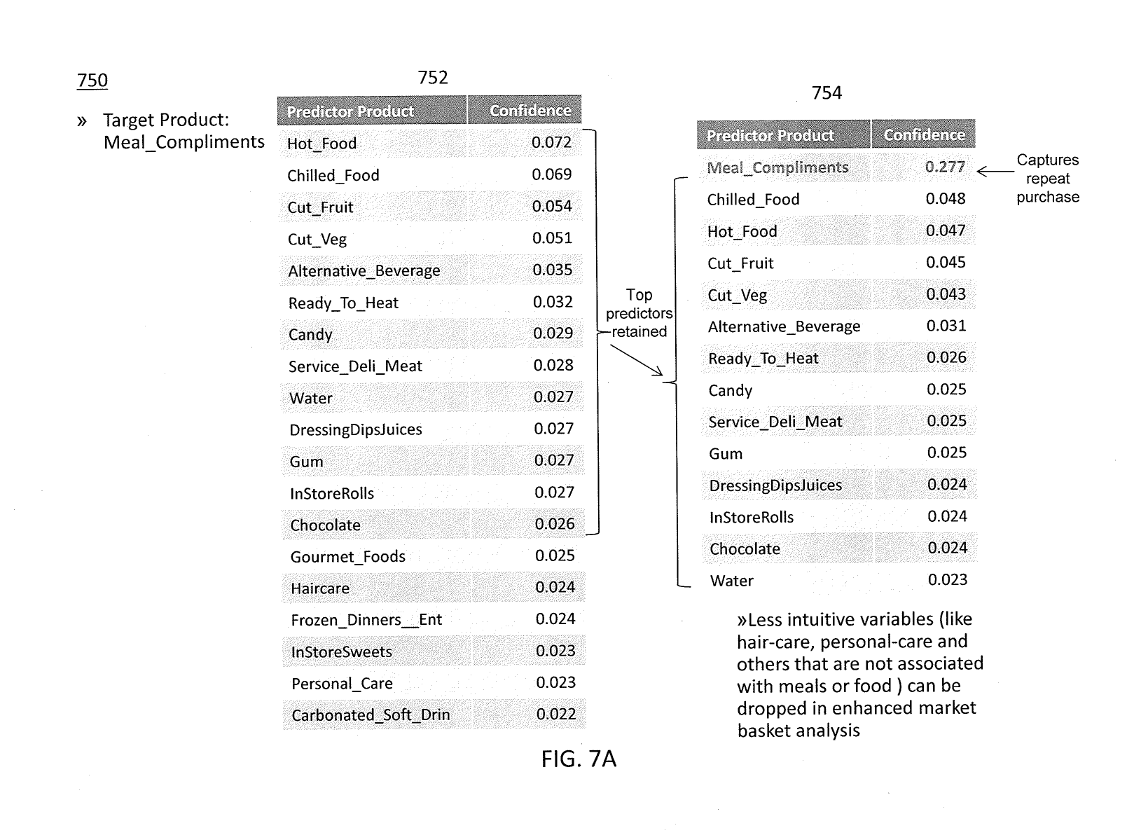

FIG. 7 is a diagram 700 illustrating the generation of the score 116. The score can be generated when a new/current product T becomes available for purchase. Herein, a new/current product refers to a product, at least two months of transaction historical data associated with which is available. From all the associations (for example, associations shown in diagram 500), associations/rules 702 that include the new/current product T as a target product can be selected. Each association 702 can be associated with a corresponding confidence value 704. From the basket data (for example, the basket data 314), baskets 706 can be selected such that each basket 706 is associated with a time-interval/trend “t” 708 and for a respective customer 710. A trend is a discretization of time, such as a day, a week, a month, fifteen days, three months, or other time-intervals. For each customer 710, the score is a confidence value that is highest amongst confidence values 704 that are associated with predictor products in a basket 706 associated with the customer 710. The score can characterize a likelihood of a purchase of the product by a corresponding customer associated with the product group.

Although the score has been described as a highest value in the confidence values, in some other implementations, the score can be computed differently in different implementations. For example, in one implementation, the score can be an average of at least some (for example, top four, top five, top six, or the like) confidence values. In another implementation, the score can be a mathematical product obtained by a multiplication of at least some (for example, top four, top five, top six, or the like) confidence values.

For example, the customer A 710 is associated with products P1, P2, P3, and T. Out of these products, P1 is associated with a confidence value of 0.05, P2 is associated with a confidence value of 0.01, and P3 is not associated with any confidence value. Out of these confidence values, 0.05 is the highest confidence value. Accordingly, customer A is allocated a score of 0.05. The score of 0.05 can characterize a likelihood of purchase of the product T by the customer A. Further, if a basket 706 contains one or more products that are not in any of the rules 702, then the score can be zero, as noted for customer C. That is, customer C is not likely to purchase the product T.

Merchants can determine appropriate offers (for example, coupons for one or more products) for each customer based on a score of the customer. For example, customer A can be provided one or more offers based on the detected scores. As noted below, the offers provided based on such scores can be effective. Further, such a strategic score-based provision of offers can be advantageous, as the number of redeemed offers is significantly higher than the number of redeemed offers when the provision of offers is based on conventional marketing techniques. Such an increase in redemption of offers can advantageously increase revenue and profits of a merchant that provides the offers.

FIG. 7A is a diagram 750 illustrating a more accurate selection of predictor products for a particular target product when the enhanced market basket analysis is implemented as compared to when a conventional market basket analysis is implemented. The target product can be meal compliments. As a prediction of the meal compliments, predictor products of table 752 are selected using a conventional market basket analysis and predictor products of table 754 are selected using the enhanced market basket analysis. While performing the enhanced market basket analysis, the products that do not affect a prediction of purchase of the target product (that is, meal components) can be removed while such products may appear in a conventional market basket analysis. As an example, such products can include a hair-care product, purchase of which does not affect the purchase of meal components. Also, enhanced market basket analysis allows capturing a repeat purchase, as shown in the predictor list of table 754 for the product meal compliments. Thus, the enhanced market basket analysis is advantageous over the conventional market basket analysis.

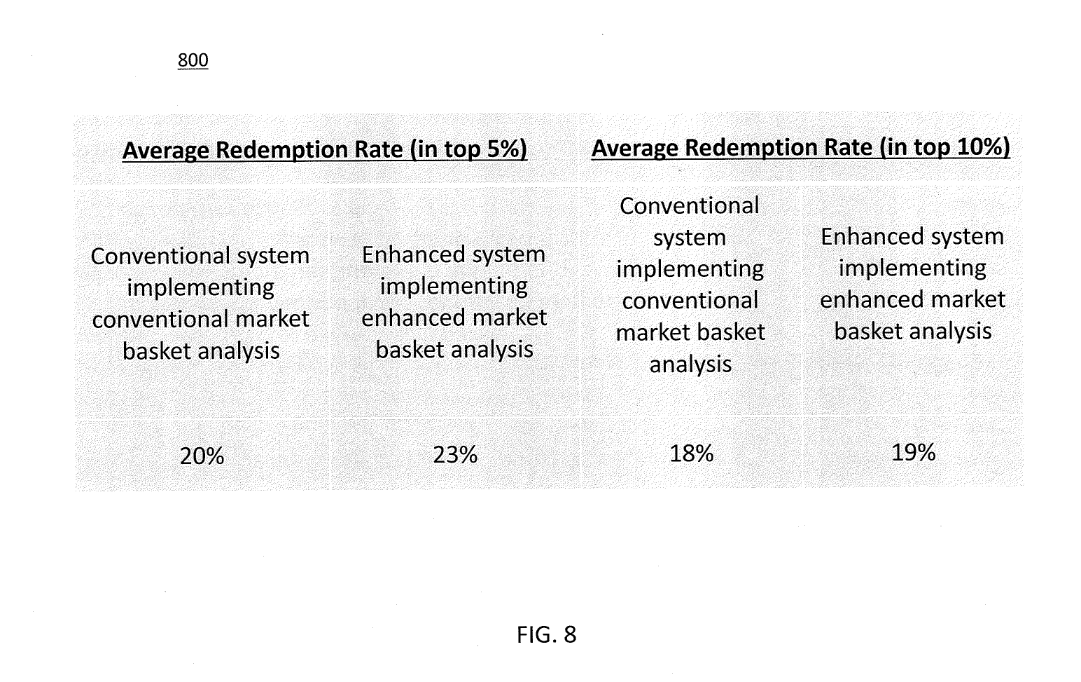

FIG. 8 is a diagram 800 illustrating an example of an improvement in an average redemption rate when offers on products are provided based on the scores 116 generated using the enhanced system of diagram 100 as compared to average redemption rate when offers are provided for products based on scores determined using conventional market basket analysis. Redemption rate can be defined as a number of offers (for example, sales promotion coupons) that are redeemed (that is, offers that are converted to purchases). This can be estimated as the percentage of customers who redeem the coupon amongst the top scoring n % customers. This number of converted offers can be expressed as a percentage of a number of distributed/marketed offers. The average redemption rate can be an average of the redemption rates across different products. Table 802 illustrates that average redemption rate is higher for the enhanced system as compared to the conventional system with varying values of “n.” Thus, it is shown that the number of redeemed offers when enhanced market basket analysis is used can be significantly higher than the number of redeemed offers when the provision of offers is based on conventional marketing techniques. Such an increase in redemption of offers can advantageously increase revenue and profits of a merchant that provides the offers.

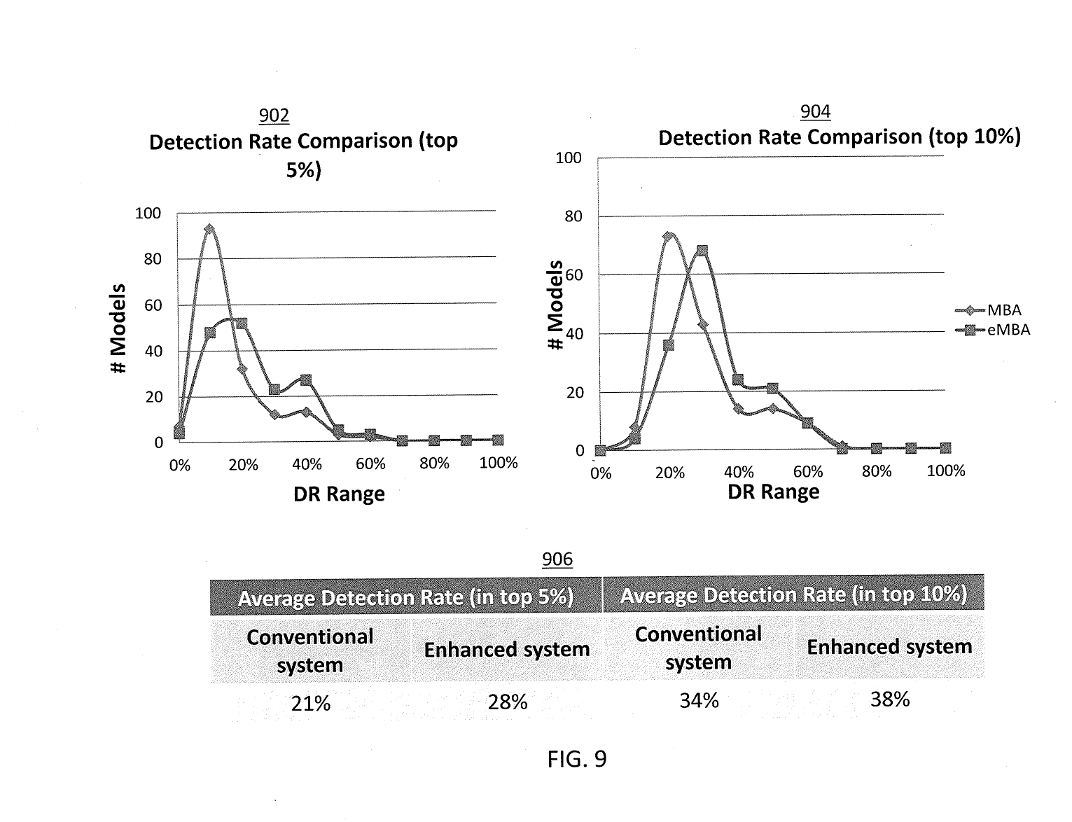

FIG. 9 is a diagram 900 illustrating an example of an improvement in an average detection rate when offers on products are provided based on the scores 116 generated using the enhanced system of diagram 100 as compared to average detection rate when offers are provided for products based on scores determined using conventional market basket analysis. Detection rate can be defined as a percentage of redeemers amongst the top scoring n % over the total redeemers for the product. The average redemption rate can be defined as an average of the detection rates across different products. Graphical diagrams 902 and 904, and table 906 illustrate that average redemption rate is higher for the enhanced system as compared to the conventional system with varying values of “n.”

Various implementations of the subject matter described herein can be realized/implemented in digital electronic circuitry, integrated circuitry, specially designed application specific integrated circuits (ASICs), computer hardware, firmware, software, and/or combinations thereof. These various implementations can be implemented in one or more computer programs. These computer programs can be executable and/or interpreted on a programmable system. The programmable system can include at least one programmable processor, which can have a special purpose or a general purpose. The at least one programmable processor can be coupled to a storage system, at least one input device, and at least one output device. The at least one programmable processor can receive data and instructions from, and can transmit data and instructions to, the storage system, the at least one input device, and the at least one output device.

These computer programs (also known as programs, software, software applications or code) can include machine instructions for a programmable processor, and can be implemented in a high-level procedural and/or object-oriented programming language, and/or in assembly/machine language. As can be used herein, the term “machine-readable medium” can refer to any computer program product, apparatus and/or device (for example, magnetic discs, optical disks, memory, programmable logic devices (PLDs)) used to provide machine instructions and/or data to a programmable processor, including a machine-readable medium that can receive machine instructions as a machine-readable signal. The term “machine-readable signal” can refer to any signal used to provide machine instructions and/or data to a programmable processor.

To provide for interaction with a user, the subject matter described herein can be implemented on a computer that can display data to one or more users on a display device, such as a cathode ray tube (CRT) device, a liquid crystal display (LCD) monitor, a light emitting diode (LED) monitor, or any other display device. The computer can receive data from the one or more users via a keyboard, a mouse, a trackball, a joystick, or any other input device. To provide for interaction with the user, other devices can also be provided, such as devices operating based on user feedback, which can include sensory feedback, such as visual feedback, auditory feedback, tactile feedback, and any other feedback. The input from the user can be received in any form, such as acoustic input, speech input, tactile input, or any other input.

The subject matter described herein can be implemented in a computing system that can include at least one of a back-end component, a middleware component, a front-end component, and one or more combinations thereof. The back-end component can be a data server. The middleware component can be an application server. The front-end component can be a client computer having a graphical user interface or a web browser, through which a user can interact with an implementation of the subject matter described herein. The components of the system can be interconnected by any form or medium of digital data communication, such as a communication network. Examples of communication networks can include a local area network, a wide area network, internet, intranet, Bluetooth network, infrared network, or other networks.

The computing system can include clients and servers. A client and server can be generally remote from each other and can interact through a communication network. The relationship of client and server can arise by virtue of computer programs running on the respective computers and having a client-server relationship with each other.

Although a few variations have been described in detail above, other modifications can be possible. For example, the logic flows depicted in the accompanying figures and described herein do not require the particular order shown, or sequential order, to achieve desirable results. Other embodiments may be within the scope of the following claims.

What is claimed is:

1. A computer-implemented method comprising:
receiving data characterizing a product available for purchase;
associating the product with at least one subgroup including the product, the at least one subgroup being at least one of a plurality of groups of historical products that have been shown to be frequently purchased together, each subgroup being associated with one or more confidence values, the data characterizing the groups including causal statuses of the historical products;
generating, using the one or more confidence values, a score characterizing a likelihood of a purchase of the product by a corresponding customer associated with the at least one subgroup; and
providing data characterizing the score.

2. The method of claim 1, wherein:
the data characterizing the product is an identifier of the product; and
the data characterizing the product includes at least one of: identity of the product, name of the product, manufacturer of the product, and a stock keeping unit associated with the product.

3. The method of claim 1, wherein:
the groups are associated with a plurality of confidence values; and
the one or more confidence values associated with the at least one subgroup are selected from the plurality of confidence values associated with the groups.

4. The method of claim 1, wherein each causal status is one of a predictor and a target.

5. The computer program product of claim 1, wherein a causal status of the product available for purchase is a target, the product being predicted based on one or more products that have a predictor causal status.

6. The method of claim 1, wherein the score is a highest confidence value in the one or more confidence values associated with each subgroup.

7. The method of claim 1, wherein the one or more confidence values are generated by:
generating baskets based on historical data collected over a time-period, each basket characterizing corresponding historical products purchased by a customer within the time-period, the historical data characterizing historical purchases of the historical products between customers and merchants;
forming, using the baskets, the groups of products that are frequently purchased together by a customer;
determining one or more ratios for the at least one subgroup, each ratio being obtained by dividing a numerator by a denominator, the numerator being a simultaneous occurrence of the one or more products and other products in the groups, the denominator being an occurrence of the other products in the groups, the one or more ratios characterizing the one or more confidence values.

8. The method of claim 7, wherein the generating of the baskets comprises:
extracting transaction data from the historical data, the transaction data comprising a unique identification of a customer for each purchase, a date of each purchase, and a stock keeping unit associated with each purchase;
obtaining a product map mapping each stock keeping unit with a respective product; and
generating, using the transaction data and the product map, basket identifiers identifying the baskets and one or more product identifiers associated with each basket identifier, each basket identifier characterizing a time-period when a corresponding customer made a purchase, the product identifier characterizing a product associated with the purchase and a causal status associated with the purchase.

9. The method of claim 8, wherein the causal status identifies the purchased product as one of: a product used to predict a purchase of another product and a product obtained based on a purchase of another product.

10. The method of claim 7, wherein the time-period is a predetermined time-period that is specified by the merchant.

11. The method of claim 7, wherein the forming of the groups of products comprises:
receiving the baskets, each basket associated with respective products;
generating a first table comprising each product and corresponding occurrence of each product in the baskets;
generating a second table by removing, from the first table, one or more products that have values of occurrence below a first threshold;
generating a third table by pairing each product in the second table with every other product in the second table to form product-sets comprising pairs of products;
generating a fourth table comprising each product-set and an occurrence of the corresponding pair of products in the baskets; and
generating a fifth table by removing one of more product-sets that have values of occurrence below a second threshold, the product-sets in the fifth table being the formed groups of products.

12. The method of claim 11, wherein the first threshold is same as the second threshold.

13. The method of claim 1, wherein the generating of the score is further based on a trend associated with the purchase.

14. The method of claim 1, wherein the providing of data comprises one or more of: transmitting data characterizing the score, displaying data characterizing the score, loading data characterizing the score, and storing data characterizing the score.

15. The method of claim 1, wherein the receiving, the associating, the generating, and the providing are implemented by at least one data processor forming part of at least one computing system.

16. A non-transitory computer program product storing instructions that, when executed by at least one programmable processor, cause the at least one programmable processor to perform operations comprising:
generating, based on historical data collected over a time-period, baskets characterizing products purchased by a customer within the time-period, the historical data characterizing historical purchases between customers and merchants;
forming, using the baskets, groups of products that are frequently purchased together by a customer;
generating one or more confidence values associated with each group of products, each confidence value characterizing a corresponding likelihood of a purchase of at least one product of the corresponding group subsequent to a purchase of other co-occurring products of the group, the one or more confidence values for each group being used to generate a score for a customer based on a product available for purchase, the score characterizing a likelihood of a purchase of the available product by the customer.

17. The computer program product of claim 16, wherein the generating of the baskets comprises:
extracting transaction data from the historical data, the transaction data comprising a unique identification of a customer for each purchase, a date of each purchase, and a stock keeping unit associated with each purchase;
obtaining a product map mapping each stock keeping unit with a respective product; and
generating, using the transaction data and the product map, basket identifiers identifying the baskets and one or more product identifiers associated with each basket identifier, each basket identifier characterizing a time-period when a corresponding customer made a purchase, the product identifier characterizing a product associated with the purchase and a causal status associated with the purchase.

18. The computer program product of claim 17, wherein the causal status identifies the purchased product as one of: a product used to predict a purchase of another product and a product obtained based on a purchase of another product.

19. The computer program product of claim 16, wherein the available product is a target product that is predicted based on one or more predictor products.

20. The computer program product of claim 16, wherein the time-period is a predetermined time-period that is specified by the merchant.

21. The computer program product of claim 16, wherein the forming of the groups of products comprises:
receiving the baskets, each basket associated with respective products;
generating a first table comprising each product and corresponding occurrence of each product in the baskets;
generating a second table by removing, from the first table, one or more products that have values of occurrence below a first threshold;
generating a third table by pairing each product in the second table with every other product in the second table to form product-sets comprising pairs of products;
generating a fourth table comprising each product-set and an occurrence of the corresponding pair of products in the baskets; and
generating a fifth table by removing one of more product-sets that have values of occurrence below a second threshold, the product-sets in the fifth table being the formed groups of products.

22. The computer program product of claim 21, wherein the first threshold is same as the second threshold.

23. The computer program product of claim 16, wherein the confidence value for the one or more products in each group is determined by dividing a numerator by a denominator, the numerator being an occurrence of the one or more products with other products in the group in the baskets, the denominator being an occurrence of the other products in the baskets.

24. The computer program product of claim 16, wherein the generating of the score is further based on a trend associated with the purchase.

25. The computer program product of claim 24, wherein the generating of the score comprises:
selecting, from the groups, subgroups that include the available product; and
determining a mathematical multiplication product of a predetermined number of top confidence values of each subgroup, the mathematical multiplication product being the score for the customer associated with the subgroup.

26. A system comprising:
at least one programmable processor; and
a machine-readable medium storing instructions that, when executed by the at least one processor, cause the at least one programmable processor to perform operations comprising:
receiving data characterizing a product available for purchase;
associating the product with at least one subgroup including the product, the at least one subgroup being at least one of a plurality of groups of historical products that have been shown to be frequently purchased together, each subgroup being associated with one or more confidence values, the data characterizing the groups including causal statuses of the historical products;
generating, using the one or more confidence values, a score characterizing a likelihood of a purchase of the product by a corresponding customer associated with the at least one subgroup; and
providing data characterizing the score.

27. The article of claim 26, wherein the product is a target product.

28. The article of claim 26, wherein the generating of the score is further based on a trend characterizing a time-interval when the product is likely to be purchased.

29. The article of claim 28, wherein the trend is determined based on a buffer window value provided by a merchant.

30. The article of claim 26, wherein the score is a mathematical average of a top predetermined number of confidence values.
